(19) United States
(12) Patent Application Publication
(10) Pub. No.: US 2007/0104953 A1
(43) Pub. Date: May 10, 2007

(54) DLC coating, and DLC coating coated tool

(75) Inventor: Hiroaki Sugita, Toyokawa-shi (JP)

Correspondence Address: OLIFF & BERRIDGE, PLC, P.O. BOX 19928, ALEXANDRIA, VA, 22320, US

(73) Assignee: OSG Corporation, Toyokawa-shi (JP)

(21) Appl. No.: 11/501,833

(22) Filed: Aug. 10, 2006

(30) Foreign Application Priority Data
Nov. 9, 2005 (JP) 2005-324971

(51) Int. Cl. B32B 9/00

(52) U.S. Cl. 428/408

(57) ABSTRACT

A DLC coating (20) coating a surface of a predetermined member (12) comprises a base layer (22) not containing hydrogen substantially, and a hydrogen containing layer (24) containing hydrogen ranging from 2 atom % to 20 atom %. The base layer (22) and the hydrogen containing layer (24) disposed thereon constitute a two-layer structure.

This application is based on Japanese Patent Application No. 2005-324971 filed Nov. 9, 2005, the contents of which are incorporated hereinto by reference.

### BACKGROUND OF THE INVENTION

1. Field of the Invention

The present invention relates to a DLC coating, in particular it relates to the DLC coating which can realize a satisfactory lifetime of a tool coated with the DLC coating, even when the tool cuts a work material of high adhesion property by a dry cutting.

2. Description of Related Art

The DLC (diamond-like-carbon) containing hydrogen (H) and carbon (C) has consolidate amorphous structure, and differs from a diamond in crystal structure thereof. However, due to high hardness and excellent abrasion proof property, it has been widely used as the coating for a cutting tool and the like to improve the abrasion proof property thereof. Japanese Patent Application Laid-open Nos. 2005-22073 and 2003-62705 respectively disclose examples of such cutting tool coated with a single layer DLC coating not containing hydrogen substantially. Japanese Patent Application Laid-open No. 2001-148112 proposes using the DLC coating in which hydrogen is positively contained as a protection coating for a recording medium.

However, when the cutting tools coated with the DLC coatings disclosed in JP 2005-22073 A JP 2003-62705 A which do not contain hydrogen substantially are used to cut the work material of high adhesion property such as aluminum alloy or copper alloy, there occurred a following problem. That is, a cutting accuracy by the cutting tool decreases in short time by adhesion of the work material to the cutting tool, whereby the cutting tool reaches a tool lifetime thereof. Such problem sometimes occurred when the work material is cut by a dry cutting which cuts the work material with using air blow without using lubricant at all, or with using mist spray of the minimum amount of lubricant.

On the other hand, the CDL coating disclosed in JP 2001-148112 A into which hydrogen is positively contained has small coefficient of friction to improve the adhesion proof property. Although such DLC coating having lowered hardness and deteriorated abrasion proof is suitable as the protection coating for the recording medium and the like, it is not suitable as the hard coating for the cutting tool.

### SUMMARY OF THE INVENTION

It is therefore an object of the present invention to provide the DLC coating and the DLC coating coated tool which can realize a practically satisfactory lifetime, even when the tool is used to cut the work material of high adhesion property by the dry cutting or the mist spraying.

(1) In order to achieve the above object, the first invention is featured by a DLC coating which is coated on a surface of a predetermined member, and which comprises a base layer not containing hydrogen substantially, and a hydrogen containing layer containing hydrogen ranging from 2 atom % to 20 atom %, wherein the base layer and the hydrogen containing layer disposed on the base layer constitute a two-layer structure.

According to the DLC coating of the first invention, the base layer not containing hydrogen substantially brings the excellent abrasion proof property, and the hydrogen containing layer on the base member decreases the coefficient of friction to bring the excellent adhesion proof property (lubrication property). That is, the hydrogen containing layer having smaller hardness than the base layer and being provided on the base layer of larger hardness is prevented from deformation, whereby the high abrasion proof property as well as the excellent adhesion proof property can be obtained.

In the first invention, a total coating thickness of the DLC coating preferably ranges 0.05 μm to 1.0 μm, and a rate of a coating thickness of the hydrogen containing layer relative to total coating thickness of the DLC coating preferably ranges from 5% to 50%.

(2) The second invention is featured by a DLC coating coated tool comprising a tool base member, and a DLC coating which coated the tool base metal, wherein the DLC coating has a two-layer structure including a base layer not containing hydrogen substantially, and a hydrogen containing layer being disposed on the base layer and containing hydrogen ranging from 2 atom % to 20 atom %. Accordingly, using of the DLC coating of the first invention for coating the tool of the second invention can suppress adhesion of the work material to the tool to thereby extend the tool lifetime, even when the tool is used to cut the work material of high adhesion property such as the aluminum alloy or the copper alloy by the dry cutting or with the mist spraying.

In the DLC coating coated tool of the second invention, total coating thickness of the DLC coating preferably ranges from 0.05 μm to 1.0 μm, and a rate of coating thickness of the hydrogen containing layer relative to a total coating thickness of the DLC coating preferably ranges from 5% to 50%.

When the coating thickness of the hydrogen containing layer is too thick, not only the abrasion proof effect of the base layer decreases, but the DLC coating is apt to be peeled off from the tool base metal. For this reason, the coating thickness of the hydrogen containing layer preferably ranges from 5% to 50% relative to the total coating thickness of the DLC coating. From a viewpoint to obtain the excellent abrasion proof property and the adhesion proof property, the total thickness of the DLC coating preferably ranges from 0.05 μm to 1.0 μm, and ranges from 0.1 μm to 0.5 μm more preferably.

(3) The DLC coating according to the first invention is coated on a surface of various cutting tools such as rotary cutting tool including an end mill, tap, drill, non-rotary cutting tool such as a bite, or form rolling tool, for giving them the adhesion proof property or abrasion proof property. It is also coated on a surface of a member other than the cutting tools as a surface protection coating thereof. As a material of the member such as the base metal on which the DLC coating is coated, a hard metal alloy or high-speed tool steel can be preferably used, but another metal material can be used.

The DLC coating coated tool according to the second invention is preferably used for the dry cutting of semi-dry cutting which cuts the aluminum alloy or copper alloy of high adhesion property with supplying the air-blowing or mist-spraying. However, the DLC coating coated tool is also used to cut various kinds of metal materials such as non-ferrous iron metal, stainless steel, in addition to the aluminum alloy or the copper alloy. Further, the DLC coating coated tool can be used in a wet cutting in which the work material is cut with supplying sufficient amount of the lubricant.

As the coating method of the DLC coating onto the tool base metal, a PVD (physical vapor deposit) method such as an arc-ion plating method which doposits the DLC coating with using graphite as a target, or spattering method can be preferably used. In such case, performing the deposition under atmosphere not containing hydrogen substantially can form the base layer not containing hydrogen substantially, while performing the deposition under atmosphere containing hydrogen with introducing hydrocarbon gas and hydrogen gas can form the hydrogen containing layer containing the predetermined amount of hydrogen.

In the DLC coating, at a boundary between the base layer and the hydrogen containing layer, hydrogen content can be increased stepwise or continuously, or presence/absence of hydrogen gas can be changed at one burst.

Here, “not containing hydrogen substantially” means that the base layer can contain as small as hydrogen which is unavoidably mixed depending on the depositing condition. The hydrogen content in the base layer is at least smaller than that in the hydrogen containing layer, and is preferably not more than 1.0 atom % normally.

In the hydrogen containing layer, if the hydrogen content is smaller than 2 atom % predetermined adhesion proof thereof can hardly obtained, and if it is more than 20 atom % the abrasion proof decreases to be easily peeled off from the base layer. For this reason, the hydrogen content should range from 2 atom % to 20 atom %, and preferably ranges from 5 atom % to 14 atom %.

The hydrogen content can be detected by for example ERDA (Elastic Recoil Detection Analysis) method. When the detected value at the surface portion of the hydrogen containing layer is extremely high by influence of hydrocarbon or water component, the hydrogen content of the inner portion except for the surface portion sufficiently may belong to the above range. In this way, the above range of the hydrogen content is not necessarily satisfied in an entire area of the hydrogen containing layer, which however depends on the detection accuracy and the analysis method. For example, an average value of the hydrogen content in the hydrogen containing layer sufficiently belongs to the above range.

The total coating thickness of the DLC coating preferably ranges from 0.05 μm to 1.0 μm. If the total coating thickness of the DLC coating is thinner than 0.05 μm effects of the abrasion proof and the adhesion proof can not be obtained sufficiently, while if it is thicker than 1.0 μm the hydrogen containing layer is apt to be peeled off from the base layer. When the coating thickness of the DLC coating varies depending on the depositing condition, the above condition is sufficiently satisfied at least in the vicinity of a cutting edge portion of the tool base metal which relates to the cutting. That is, above condition is not necessarily satisfied in a chip discharge groove of the tool base metal which discharges the chip upon cutting.

A rate of the coating thickness of the hydrogen containing layer relative to the total coating thickness of the DLC coating preferably ranges from 5% to 50%. If this rate is smaller than 5% the effect of abrasion proof can not be obtained sufficiently, while if it is larger than 50% the effect of abrasion proof by the base layer decreases and the hydrogen containing layer may be easily peeled off from the base layer. For obtaining more excellent abrasion proof property, this rate preferably ranges from 5% to 30%.

### BRIEF DESCRIPTION OF THE DRAWINGS

FIG. 1 shows an end mill which is one embodiment of the present invention, in which FIG. 1A is a schematic front view of the end mill as viewed from a perpendicular direction to an axis thereof, FIG. 1B is an end view of the end mill viewed from a tip end thereof, and FIG. 1C is a cross-section of a surface portion of a cutting edge coated with a DLC coating;

FIG. 2 is a table explaining three kinds of the DLC coatings having different coating thickness and the like;

FIG. 3 is a view explaining a test equipment for carrying out an abrasion proof test with test pins coated with each of the DLC coatings of FIG. 2;

FIG. 4 shows an abrasion trace occurred in a top spherical portion of each of three kinds of the test pins each coated with the three kinds of DLC coatings of FIG. 2, when they are subjected to the abrasion proof test by the test equipment shown in FIG. 3, in which FIG. 4A is a photograph of an embodiment, FIG. 4B is a photograph of an comparative sample, and FIG. 4C is a photograph of a prior art;

FIG. 5 is a graph showing coefficients of friction of the two kinds of test pins coated with the DLC coatings of the embodiment and the comparative sample of FIG. 2, which are obtained through the test performed by the test equipment of FIG. 3;

FIG. 6 is a graph showing coefficients of friction of the two kinds of test pin coated with the DLC coatings of the embodiment and the prior art of FIG. 2, which are obtained through the test performed by the test equipment of FIG. 3;

FIG. 7A is a table showing test conditions for testing the abrasion proof during predetermined cutting, and FIG. 7B is a view explaining an adhesion width;

FIG. 8 is a table explaining the adhesion widths at the rake face, for plural kinds of test pieces which are different in the rate of the coating thickness of the surface layer relative to the total thickness of the DLC coating, which are obtained through the test performed under test conditions shown in FIG. 7A;

FIG. 9 is a table explaining the adhesion width at the rake face, for plural kinds of test pieces which are different in the hydrogen content of the surface layer of the DLC coating, which are obtained through the test performed under test conditions shown in FIG. 7A; and

FIG. 10 is a table explaining the adhesion width at the rake face, for plural kinds of test pieces which are different in the each coating thickness and the total coating thickness of the DLC coating which are obtained through the test performed under test conditions shown in FIG. 7A.

### DETAILED DESCRIPTION OF EXEMPLARY EMBODIMENTS

Hereinafter, the embodiment of the present invention will be explained with reference to attached drawings.

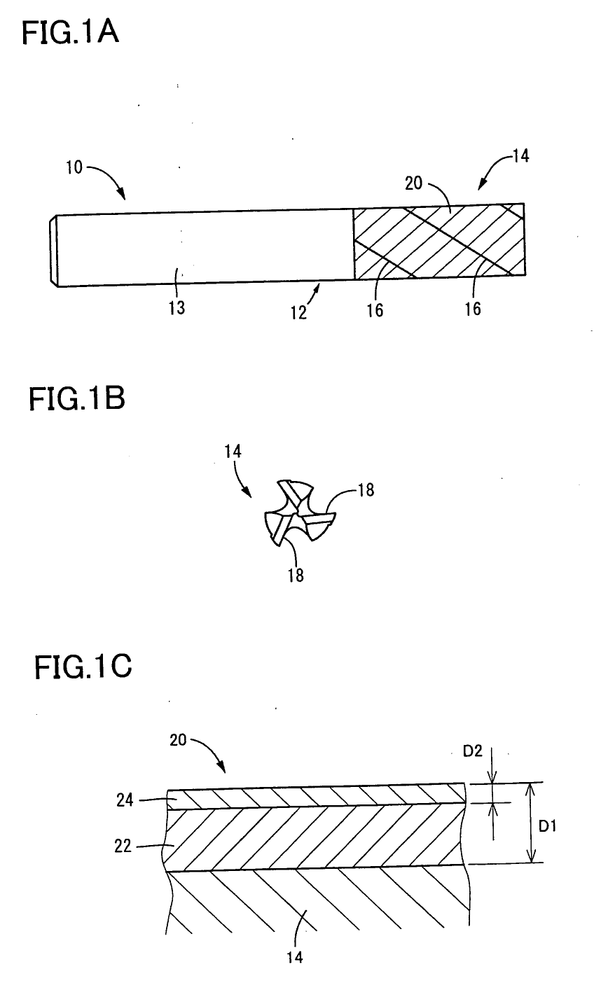

FIG. 1 shows an end mill 10 which is one example of the DLC coating coated tool according to the present invention, in which FIG. 1A is a schematic front view of the end mill 10 viewed from a direction perpendicular to an axis thereof, and FIG. 1 B is an end view of the end mill 10 viewed from a top end thereof.

This end mill 10 is a square end mill having three cutting parts, and has a base metal 12 which is made of a cemented carbide and which includes a shank portion 13 and a cutting part 14 formed integrally with each other. On the cutting part 14, a peripheral cutting edge 16 and an end cutting edge 18 are provided as a cutting part, to perform the cutting when the tool is rotated around the axis thereof by a driving source (not shown).

A surface of the cutting part 14 is coated with a DLC coating 20. The DLC coating 20 is coated on the cutting part 14 as shown by a cross-hatch in FIG. 1A, and has a cross-sectional structure shown in FIG. 1C. Here, the end mill 10 corresponds to a rotary cutting tool, and the tool base metal 12 corresponds to a claimed predetermined member which is coated with the DLC coating 20.

As apparent from FIG. 1C, the DLC coating 20 has a two-layer laminated structure including a base layer 22 provided on a surface of the cutting part 14, and a surface layer 24 laminated on the base layer 22. The base layer 22 is a layer which does not contain hydrogen substantially except for hydrogen unavoidably mixed upon coating of the DLC coating 20, and a hydrogen content thereof is not more than 1.0 atom %.

On the other hand, into the surface layer 24 which corresponds to the hydrogen containing layer, hydrogen is positively introduced upon coating the DLC coating 20, and hydrogen content ranges from 2 atom % to 20 atom %. A total coating thickness Dl of DLC coating 20 ranges from 0.05 μm to 1.0 μm, and a coating thickness D2 of the surface layer 24 ranges from 5% to 50% relative to the total coating thickness D1.

The DLC coating 20 is formed by an arc-ion plating method which uses graphite as a target upon deposition. In this case, the base layer 22 is deposited on the cutting part 14 under an atmosphere not containing hydrogen, while the surface layer 24 is deposited on the base layer 22 under an atmosphere containing hydrogen into which predetermined amount of hydrocarbon gas and hydrogen gas are introduced. Thus, the predetermined amount of hydrogen is contained in the surface layer 24.

The hydrogen content can be detected by for example ERDA method. Here, the detected value on the surface portion may become extremely high by an influence of attached matter such as hydrocarbon or water component. For this reason, the hydrogen content of an inner portion except for the surface portion sufficiently ranges from 2 atom % to 20 atom %. It is noted that an entire area of the surface layer 24 does not necessarily satisfies the above hydrogen content, and therefore the average value of the hydrogen content in the surface layer 24 belongs to the above range in this embodiment.

According to the end mill 10 in which the cutting part 14 of the tool base metal 12 is coated with the DLC coating 20, the base layer 22 which does not contain hydrogen substantially brings the excellent abrasion proof property, and the surface layer 24 being disposed on the base layer 22 and containing the predetermined amount of hydrogen bring the small frictional coefficient to realize the excellent abrasion proof property (lubricant property). That is, the surface layer 24 having smaller hardness than the base layer 22 is prevented from deformation thereof by being disposed on the base layer 22 of higher hardness.

In this way, even when the end mill 10 cuts the work material such as the aluminum alloy or copper alloy of high adhesion property by the dry cutting or the mist spraying, the adhesion of the work material to the end mill 10 is suppressed, so that lifetime of the tool is extended.

On the other hand, as the coating thickness of the surface layer 24 becomes larger, the abrasion proof property by the base layer 22 decreases and the surface layer 24 is apt to be peeled off from the base layer 22. However, in the embodiment, the total coating thickness of the DLC coating 20 ranges 0.05 μm to 1.0 μm, and the coating thickness D2 of the surface layer 24 relative to the total coating thickness D1 of the DLC coating 20 ranges from 5% to 50%. As a result, the adhesion proof property is increased by the surface layer 14, with maintaining the abrasion proof property by the base layer 22.

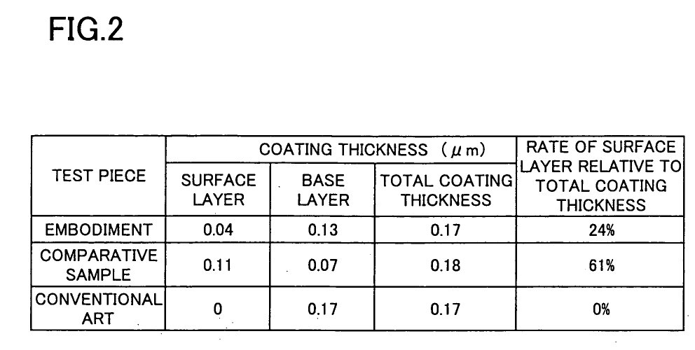

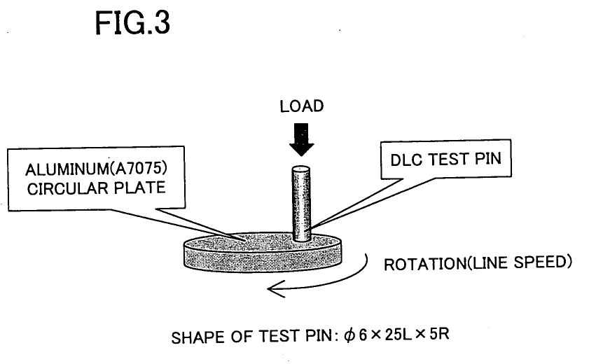

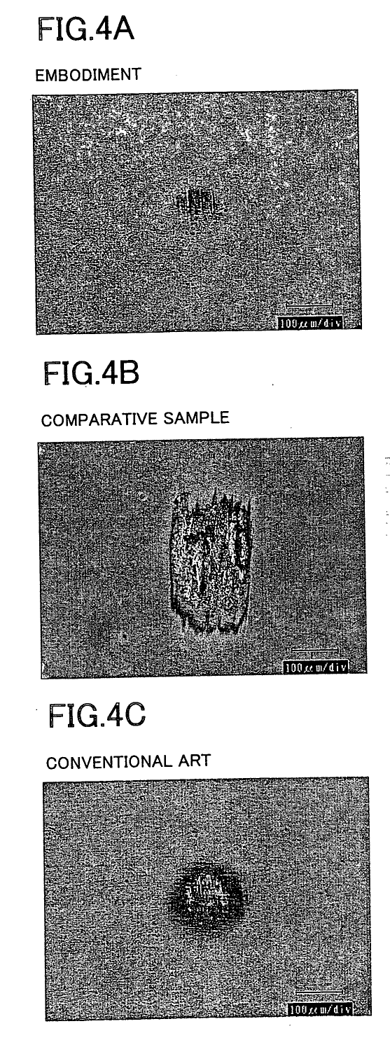

The test pins of the embodiment, comparative sample, and prior art respectively coated with each of the DLC coatings shown in FIG. 2 are subjected to an abrasion proof test under following test conditions with the test equipment shown in FIG. 3. Through the abrasion proof test, the result shown in FIG. 4 was obtained. Here, the test pin has a cylindrical shape which is 6 mm in diameter and 25 mm in length, and of which top end is rounded by radius of 5 mm. Here, “the rate of the surface layer relative to the total thickness” in FIG. 2 means the rate D2/D1 of the coating thickness D2 relative to the total coating thickness D1, of the DLC coating 20. The hydrogen content of the surface layer 24 is 10 atom %, while the hydrogen content of the base layer 22 is not more than 1.0 atom %.

<Test Conditions>

work material: A7075 (aluminum alloy)
load: 500 g
line speed: 100 mm/s
time period: 1000 sec.

FIG. 4A to FIG. 4C show abrasion traces at the top spherical surface of the test pins. As apparent, the abrasion trace of the embodiment shown in FIG. 4A is the smallest, which contributes to obtain the excellent lubricant property and abrasion proof property. In the comparative sample which has the surface layer 24 containing hydrogen, the rate of the coating thickness D2 relative to the total thickness DI of the DLC coating 20 is as high as 61%. For this reason, the effect of the abrasion proof property by the base layer 22 can not be obtained, and the surface layer 24 is easily peeled off from the base layer 24. Thus, the abrasion proof property of the comparative sample is worsened compared with that of the conventional art, so that the comparative samples has the largest abrasion trace.

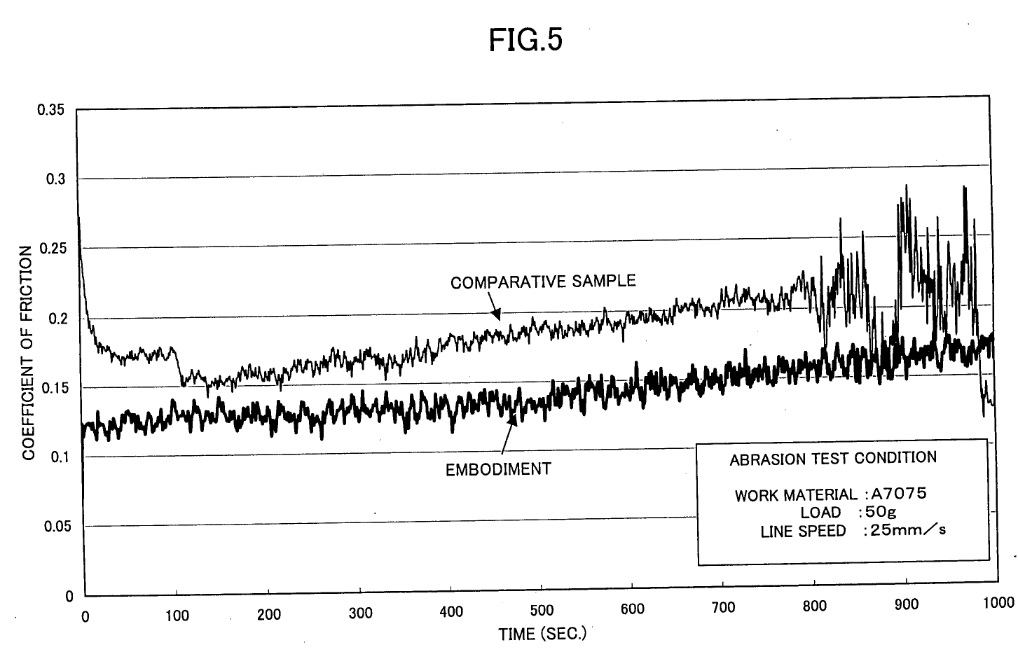

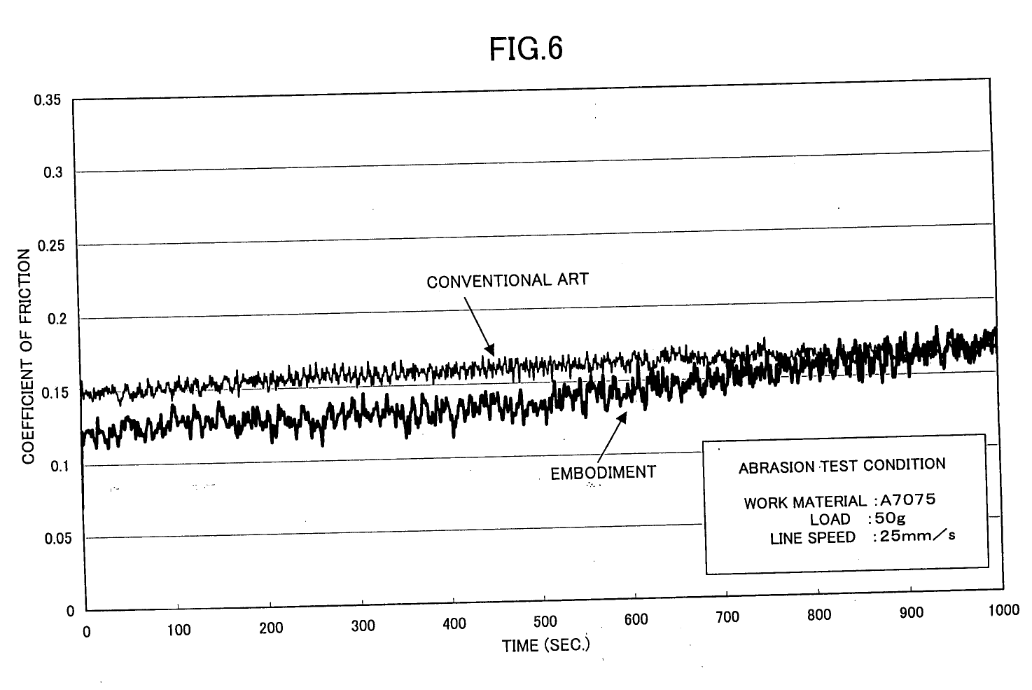

FIG. 5 and FIG. 6 are diagrams showing result in which the coefficient of friction is tested under following test conditions, with the same test piece and the test equipment as that shown in FIG. 2 and FIG. 3. From FIG. 5 for comparing the embodiment with the comparative sample, it can be observed that the coefficient of friction of the embodiment is smaller than that of the comparative sample by about 0.05 to 0.1, which brings the excellent lubricant property of the embodiment. In the comparative sample, the DLC coating 20 is peeled off from the base body of the test piece, so that the base body is exposed to be worn. Due to such abrasion, the coefficient of friction of the comparative sample increases with larger inclination than that of the embodiment.

From FIG. 6 for comparing the embodiment with the conventional art, it can be observed that the coefficient of friction of the embodiment is smaller than that of the conventional art in the time period shorter than 800 sec. Thus, the excellent lubricant property is brought on account of existence of the surface layer 24.

<Test Conditions>

work material: A7075 (aluminum alloy)
load: 50 g
line speed: 25 mm/s

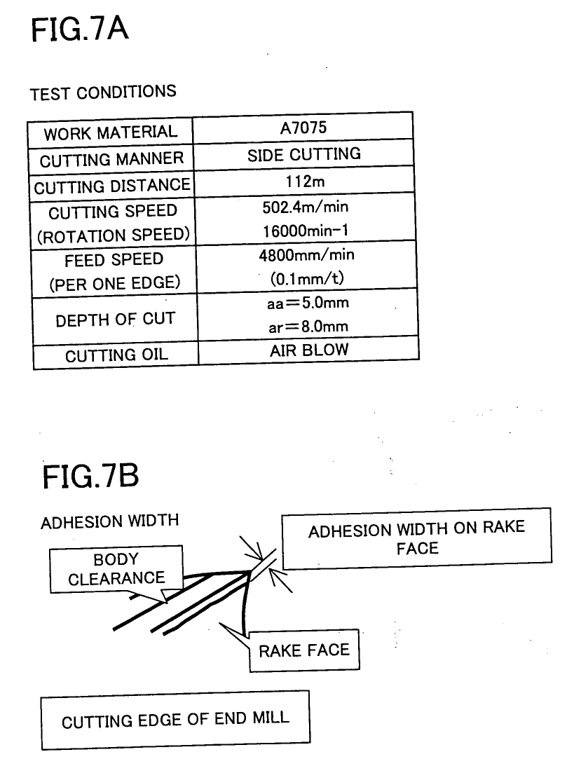

FIG. 7 to FIG. 10 are tables or diagram which explain results of the adhesion proof property test performed by using the square end mill having three cutting blades, which is similar to the above-mentioned end mill 10 of the embodiment. In the abrasion proof test, plural end mills are prepared in which following factors are changed. The changed factors are the rate D2/D1, that is, “the rate of the coating thickness of surface layer relative to the total coating thickness ”, “the hydrogen content of the surface layer”, and “coating thickness” of each layer and total layers of the DLC coating 20.

FIG. 7A shows the test condition, and FIG. 7B is a view explaining “the adhesion width on rake face” in which the small adhesion width means the excellent abrasion proof property.

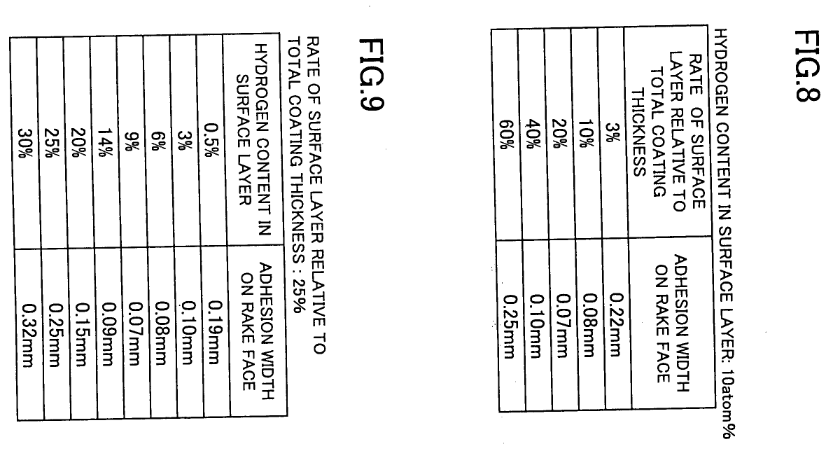

FIG. 8 is a table explaining relation between the rate of the coating thickness of the surface layer 24 relative to the total coating thickness, and the adhesion width of the rake face, in the case of the hydrogen content on the surface layer being 10 atom %. The rate is varied to prepare the plural kinds of DLC coatings 20 to be coated on the test pieces which are used to cut the work material. Upon the cutting, the adhesion width on the rake face is measured.

FIG. 9 is a table explaining relation between the hydrogen content of the surface layer and the adhesion width on the rake face, in the case the rate D2/D1 of the coating thickness D2 of the surface layer 24 to the total coating thickness D1 being 25%. The hydrogen content is varied to prepare the plural kinds of DLC coatings 20 to be coated on the test pieces which are used to cut the work material. Upon the cutting, the adhesion width on the rake face is measured.

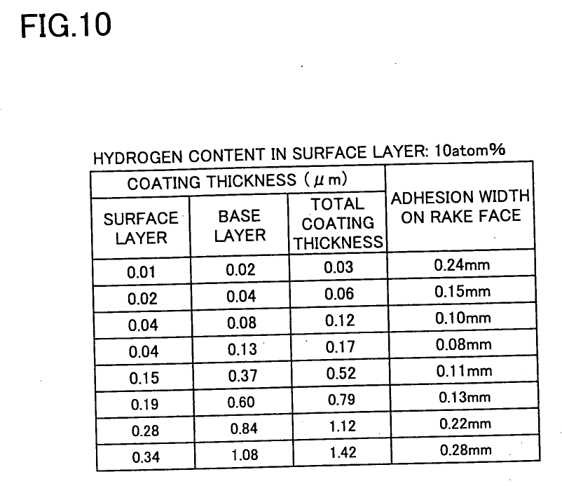

FIG. 10 a table explaining relation between the coating thickness and the adhesion width on the rake face, in the case of the hydrogen content in the surface layer 24 being 10 atom %. Thickness of the base layer 22, the surface layer 24 and total layer are varied to prepare the plural kinds of DLC coatings 20 to be coated on the test pieces which are used to cut the work material. Upon the cutting, the adhesion width on the rake face is measured.

Here, in all the cases, the hydrogen content of the base layer 22 is not more than 0.1 atom %, and the total thickness D1 of the DLC coating 20 of the test piece shown in FIG. 8 and FIG. 9 ranges from 0.15 μm to 0.2μm. Also, “%” in the column of “the hydrogen content of the surface layer” means “the atom %”.

From the result described in FIG. 8, it can be observed that when the coating thickness rate D2/D1 ranges from 5% to 50%, the adhesion width becomes approximately 0.2 mm to realize the excellent adhesion proof property. Also, considering the adhesion width becomes not more than 0.10 mm in a case this rate being not more than 40%, the rate ranging from 5% to 30% is especially preferable.

From the result described in FIG. 9, it can be observed that when the hydrogen content of the surface layer 24 ranges from 2 atom % to 20 atom %, the adhesion width becomes approximately 0.2 mm to realize the excellent adhesion proof property. Especially, in the range from 5 atom % to 14 atom %, the adhesion width becomes below 0.10 mm to realize more excellent abrasion proof property.

From the result of FIG. 10, it can be observed that when the total coating thickness of the DLC coating 20 ranges from 0.05 μm to 1.0 μm, the adhesion width becomes approximately 0.2 mm to realize the excellent adhesion proof property.

Especially, in the range from 0.1 μm 0.5 μm, the adhesion width becomes below 0.10 mm to realize more excellent abrasion proof property.

It is to be understood that the present invention may be embodied with other changes, improvements, and modifications that may occur to a person skilled in the art, without departing from the scope and spirit of the invention defined in the appended claims.

What is claimed is:

1. A DLC coating which coats a surface of a predetermined member comprising:
a base layer not containing hydrogen substantially; and
a hydrogen containing layer containing hydrogen ranging from 2 atom % to 20 atom %,
wherein the base layer and the hydrogen containing layer disposed thereon constitute a two-layer structure.

2. The DLC coating according to claim 1, wherein a total coating thickness of the DLC coating ranges 0.05 μm to 1.0 μm, and preferably ranges 0.1 μm to 0.5 μm.

3. The DLC coating according to claim 2, wherein a coating thickness of the hydrogen containing layer ranges from 5% to 50% of the total coating thickness of the DLC coating.

4. The DLC coating according to claim 1, wherein a hydrogen content of the hydrogen containing layer ranges 5 atom % to 14 atom %.

5. The DLC coating according to claim 1, wherein the base layer contains hydrogen of approximately 1.0 atom %.

6. The DLC coating according to claim 1, wherein the predetermined member is a tool base metal made of a hard metal alloy or high-speed tool metal.

7. A DLC coating coated tool comprising:
a tool base metal; and
a DLC coating which coated the tool base metal,
wherein the DLC coating has a two-layer structure including a base layer not containing hydrogen substantially, and a hydrogen containing layer being disposed on the base layer and containing hydrogen ranging from 2 atom % to 20 atom %.

8. The DLC coating coated tool according to claim 7 wherein a total coating thickness of the DLC coating ranges 0.05 μm to 1.0 μm.

9. The DLC coating coated tool according to claim 8, wherein a coating thickness of the hydrogen containing layer ranges from 5% to 50% of the total coating thickness of the DLC coating.

10. The DLC coating coated tool according to claim 7, wherein the DLC coating coated at least a cutting edge of the tool base metal.

11. The DLC coating coated tool according to claim 7, wherein the DLC coating coated tool is used to cut a work material made-of aluminum alloy or copper alloy.
